(19) United States
(12) Patent Application Publication
(10) Pub. No.: US 2025/0196262 A1
(43) Pub. Date: Jun. 19, 2025

(54) MOTION CONTROL METHOD AND APPARATUS OF LASER DEVICE, AND DEVICE

(71) Applicant: MAKEBLOCK CO., LTD., Shenzhen, Guangdong (CN)

(72) Inventor: JUNHUA DONG, Shenzhen, Guangdong (CN)

(21) Appl. No.: 18/724,383

(22) PCT Filed: Sep. 21, 2022
(86) PCT No.: PCT/CN2022/120330

§ 371 Date: Jun. 26, 2024

(30) Foreign Application Priority Data
Dec. 30, 2021 (CN) 202111661020.X
Mar. 31, 2022 (CN) 202210333532.1

(51) Int. Cl. B23K 26/082; G05B 19/31

(52) U.S. Cl. CPC B23K 26/082; G05B 19/31

(57) ABSTRACT

Provided are a motion control method and apparatus in a desktop smart laser device, and a desktop smart laser device. The method comprises: for data configured as motion control in a cache region, sequentially generating trajectory point queues for the desktop smart laser device to execute laser process (S210); pre-scanning a curve of the trajectory point queues, and positioning head and tail trajectory points of a mapped curve segment (S220); pre-calculating the motion of covered trajectory points according to the head and tail of the mapped curve segment to obtain instruction parameters for operating the trajectory points, and updating the instruction parameters to the trajectory point queues (S230); and traversing the trajectory point queues, and executing, according to traversed trajectory point motion instructions, the operation of the desktop smart laser device at the trajectory points until the traversal ends (S240).

### CROSS-REFERENCE TO RELATED APPLICATION

The present application is a national stage entry under 37 U.S.C. § 371 of International Application No. PCT/CN2022/120330. filed Sep. 21, 2022, which claims priority to Chinese Patent Application No. 202111661020.X, filed on Dec. 30, 2021, and Chinese Patent Application No. 2022103335321, filed on Mar. 31, 2022, the entire disclosures of which are incorporated herein by reference.

### TECHNICAL FIELD

The present application relates to a field of communication technology, and particularly to a motion control method, an apparatus of a laser device and a desktop smart laser device.

### BACKGROUND

With the development of advanced technologies such as computers and the creation of high degrees of freedom, the traditional industrial laser cutting machine has been revolutionized and optimized by advanced technologies to become a user-level desktop smart hardware product, i.e., a desktop smart laser device, which enables the user to carry out laser cutting and engraving based on their own requirements.

However, the user-level desktop smart laser device is after all different from the traditional industrial laser cutting machine, how the actuator, used by the desktop smart laser device for laser cutting and engraving, operates, and how the desktop smart laser device controls its motion, need to be solved by the desktop smart laser device.

### SUMMARY

There are provides a motion control method and a desktop smart laser device according to embodiments of the present disclosure. The technical solution is as below. According to an aspect of an embodiment of the present application, the present application provides a motion control method of a laser device, including:
sequentially generating the trajectory point queue for the desktop smart laser device to perform laser process based on data configured for motion control in the cache, wherein a trajectory point motion command in queue elements in the trajectory point queue is configured to instruct the laser process operated by corresponding trajectory points;
pre-scanning a curve of the trajectory point queue to locate head and tail trajectory points of a mapped curve segment;
pre-calculating a motion of trajectory points covered by and based on the head and tail trajectory points of the mapped curve segment, to obtain command parameters for operating the trajectory points, and updating the command parameters to a corresponding trajectory point motion command in the trajectory point queue; and
traversing the trajectory point queue, performing operations of the desktop smart laser device at the trajectory points based on the traversed trajectory point motion command until an end of the traversal.

According to an aspect of an embodiment of the present application, the present application provides a desktop smart laser device, including:
a memory, storing a computer readable command;
a processor, reading the computer readable command stored in the memory to perform the method as mentioned above.

Other features and advantages of the present application becomes apparent by the following detailed description, or are acquired in part by the practice of the present application.

It should be understood that the above general description and the detailed descriptions that follow are merely exemplary and do not limit the present application.

### BRIEF DESCRIPTION OF THE DRAWINGS

The foregoing and other objects, features,, and advantages of the present application will become more apparent by describing in detail exemplary embodiments thereof with reference to the accompanying drawings.

FIG. 1 shows an architecture diagram of a motion control method that should be configured for a desktop smart laser device according to an embodiment of the present application.

FIG. 2 shows a flowchart of a motion control method in the desktop smart laser device according to an embodiment of the present application.

FIG. 3 shows a flowchart of the motion control method in the desktop smart laser device according to an embodiment of the present application.

FIG. 4 shows a flowchart of the step of taking data configured for motion control in a cache to sequentially generate a trajectory point queue for the desktop smart laser device to perform laser engraving or cutting according to an embodiment of the present application.

FIG. 5 shows a flowchart of the step of pre-scanning a curve of the trajectory point queue to locate head and tail trajectory points of a mapped curve segment according to an embodiment of the present application.

FIG. 6 shows a flowchart of the step of pre-calculating a motion of trajectory points covered based on the head and tail trajectory points of the mapped curve segment, obtaining command parameters for operating the trajectory points, and updating the command parameters to a corresponding trajectory point motion command in the trajectory point queue according to an embodiment of the present application.

FIG. 7 shows a flowchart of the step of traversing the trajectory point queue, performing an operation of the desktop smart laser device at the trajectory point based on the traversed trajectory point motion command until an end of the traversal according to an embodiment of the present application.

FIG. 8 shows a block diagram of a motion control device in a desktop smart laser device.

FIG. 9 shows a hardware structure diagram of a desktop smart laser device according to an embodiment of the present application.

### DETAILED DESCRIPTION OF THE EMBODIMENTS

Embodiments will now be described more fully with reference to the accompanying drawings. However, the embodiments are capable of being implemented in a variety of forms and should not be construed as being limited to the examples set forth herein; rather, the provision of these embodiments allows for the description of the present application to be more comprehensive and completely conveys the idea of embodiments in a comprehensive manner to those skilled in the art. The accompanying drawings are only schematic illustrations of the present application and are not necessarily to scale. Identical accompanying symbols in the drawings indicate identical or similar parts, and thus repetitive descriptions of them will be omitted.

In addition, the features, structures, or characteristics described may be combined in one or more embodiments in any suitable manner. In the following description, many specific details are provided to give a full understanding of the embodiments of the present application. However, those skilled in the art will realize that it is possible to practice the technical embodiments of the present application and omit one or more of the particular details described, or that other methods, groups of elements, steps, etc. may be employed. In other cases, the publicly known structures, methods, implementations, or operations are not shown or described in detail to avoid overshadowing and obscuring aspects of the present application.

Some of the block diagrams shown in the accompanying drawings are functional entities that do not necessarily correspond to physically or logically separate entities. These functional entities may be implemented in software form, or in one or more hardware modules or integrated circuits, or in different networks and/or processor devices and/or microcontroller devices.

Referring to FIG. 1, FIG. 1 shows an architecture applied by embodiments of the present application. The architecture may include: at least one external device 11, such as a host computer, and a desktop smart laser device 12 facing each external device 11 as a means of constituting functionality for a user to be able to customize to perform laser engraving or cutting. The external device 11 and the desktop smart laser device 12 interact with each other via an adapted communication port for data communication.

After a processing task is generated by the host computer based on a hand-drawn work, according to the processing task, the host computer, based on the curve trajectory presented in the hand-drawn work, generates an executable file, such as a G-code file, and splits the executable file into a number of frames of data based on predefined rules.

The frames of data are sent through the host computer to the desktop smart laser device 12, which receives the frames of data sequentially from the host computer through a specific communication port, such as a universal serial bus (USB) port, or a serial communication port, and stores them in a cache.

The curved trajectory in the hand-drawn work is realized by the desktop smart laser device 12 executing the laser engraving or cutting of each trajectory point on basis of the given data stored in the cache, i.e. operating the execution mechanism that is used to perform the laser cutting or engraving at each trajectory point, and the desktop smart laser device controls its motion and ultimately cuts and/or engraves to obtain the hand-drawn graphic.

It should be understood that the number of external devices 11 in FIG. 1 is merely exemplary, There may be any number of external devices 11 as needed for implementation.

Some of the technical solutions of embodiments of the present application may be concretely implemented based on an architecture shown in FIG. 1 or a morphing architecture thereof.

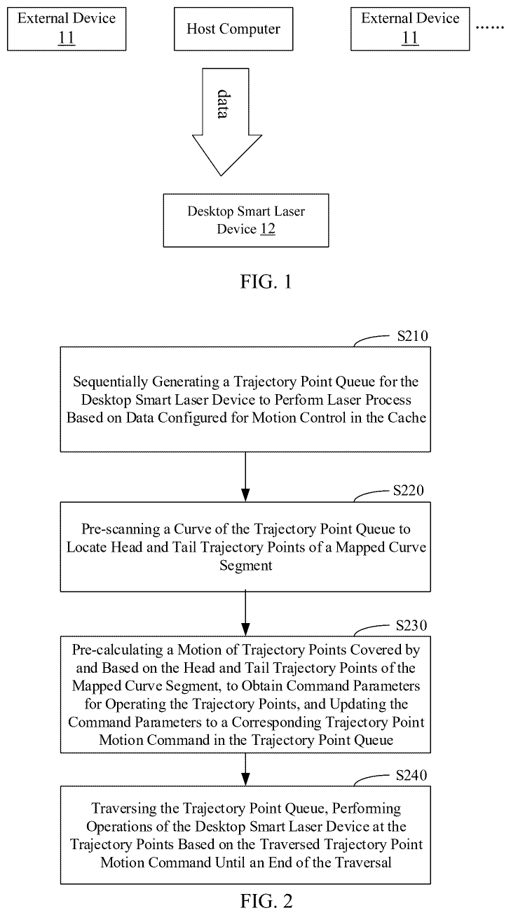

Referring to FIG. 2, FIG. 2 shows a flowchart of a motion control method in a desktop smart laser device according to an embodiment of the present application, the embodiment of the present application provides a motion control method in the desktop smart laser device.

The motion control method in the desktop smart laser device includes:

Step S210, sequentially generating a trajectory point queue for the desktop smart laser device to perform laser process based on data configured for motion control in a cache. A trajectory point motion command in queue elements in the trajectory point queue is configured to instruct the operation of laser process of corresponding trajectory points.

Step S220, pre-scanning a curve of the trajectory point queue to locate head and tail trajectory points of a mapped curve segment.

Step S230, pre-calculating a motion of trajectory points covered by and based on the head and tail trajectory points of the mapped curve segment, to obtain command parameters for operating the trajectory points, and updating the command parameters to a corresponding trajectory point motion command in the trajectory point queue.

Step S240, traversing the trajectory point queue, performing operations of the desktop smart laser device at the trajectory points based on the traversed trajectory point motion command until an end of the traversal.

The four steps are described in detail below.

In step S210, it should first be explained that the desktop smart laser device is adapted to each communication port, and the corresponding cache is divided for each communication port, and the external data received by the desktop smart laser device through the communication port will be stored in the corresponding cache for use.

The desktop smart laser device receives, including but not limited to data for motion control, through a specific communication port and stores the data in a cache corresponding to this specific communication port. The data for motion control in the cache is a number of frames of data sent sequentially by the external device, which will be configured to control the motion of the corresponding actuator of the desktop smart laser device based on each trajectory point and the use of the laser.

Therefore, in the order of reception, the desktop laser device takes out frames of data to sequentially generate the trajectory point queue. The queue elements in the trajectory point queue all contain trajectory point motion command which carries a number of command parameters, e.g. the position of the point on the corresponding curved trajectory, the type of point etc. It should be understood that the trajectory point motion command contained in the queue elements will be not only used to describe the trajectory point at which the laser cutting or engraving is to be performed, and but also used to indicate the motion state of the actuator at that trajectory point.

The generation of the trajectory point queue is a process whereby data for motion control is continuously taken out of the cache and converted into trajectory point motion command, which are then added to the queue. The trajectory point motion command forms the data existed in the queue elements.

Exemplarily, the desktop smart laser device receives external data from a communication port, stores and processes the external data through a hierarchical cache corresponding to the communication port as a means of obtaining the data for motion control stored in the cache. Specifically, in response to the external data received from the communication port, the central processing unit (CPU) of the desktop smart laser device interrupts the current process of programme execution, takes out the external data received from the communication port during the interruption of the process of programme execution, stores the external data in the first level cache configured for the communication port, and returns to continue the execution of the interrupted process of programme execution.

The first level cache only corresponds to the communication port and is used for storing the external data received by the corresponding communication port. In contrast to the first level cache, a second level cache is also configured for the communication port for storing valid data in the first level cache. The data stored for motion control is the valid data, and is stored in the second level cache.

For the external data stored in the corresponding first level cache for each communication port, the data is obtained from the first level cache based on the order of data reception, the data is verified to obtain the valid data, and is stored in the second level cache corresponding to the communication port, which may be a ring-shaped cache, i.e., a second level ring-shaped cache.

It is to be clarified that for the second level ring-shaped cache, a read pointer and a write pointer are set. The read pointer is configured to point to the readable data in the second level ring-shaped cache, and the write pointer is configured to point to the writable data in the ring-shaped cache, and the reading and writing of the data in the second level ring-shaped cache is achieved by moving the read pointer and the write pointer.

In the execution of step S210, the desktop smart laser device sequentially takes out the data for motion control that is continuously stored in the second level ring-shaped cache, and parses the data, and converts the data into the trajectory point motion command, which are then added to the trajectory point queue. The second level ring-shaped cache continuously stores data, and also continuously parses and converts the data, so that as much data as possible is converted into the trajectory point motion command, which correspondingly enables the laser engraving or cutting performed by the desktop smart laser device to operate based on more trajectory points, to realize a more detailed and accurate processing.

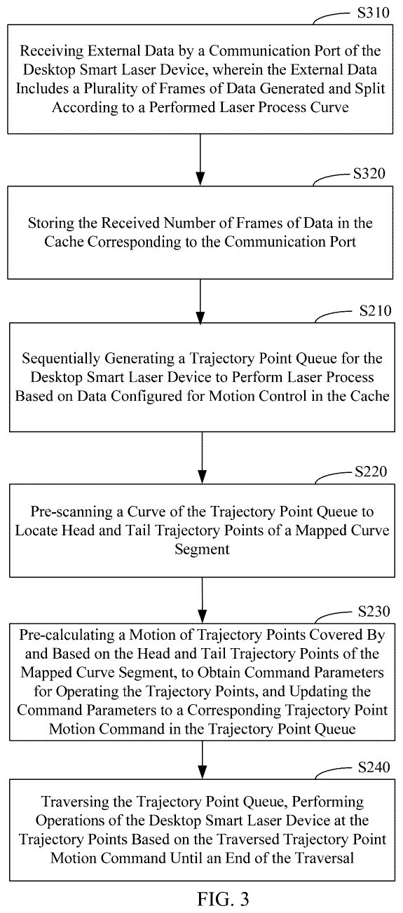

Referring to FIG. 3, FIG. 3 shows a flowchart of a motion control method in a desktop smart laser device according to an embodiment of the present application. In this embodiment of the present application, after performing the step of sequentially generating the trajectory point queue for the desktop smart laser device to perform laser engraving or cutting based on data configured for motion control in the cache, that is, after performing step S210;

The motion control method in the desktop smart laser device further includes:

Step S310, receiving external data by a communication port of the desktop smart laser device. The external data includes a plurality of frames of data generated and split by a performed laser process curve.

Step S320, storing the received number of frames of data in the cache corresponding to the communication port.

Each of these steps is described in detail below:

In step S310, as previously described, any one of the communication ports of the desktop smart laser device receives external data, and the received external data of course includes data configured for motion control. When the communication port of the desktop smart laser device is triggered to receive the external data, the CPU will temporarily stop the operation of the current program and give priority to receive the external data.

Specifically, the CPU removes the external data received by the communication port and stores it in the first level cache, and after completing the storage of the external data, the CPU returns to continue operating the current program, so as to ensure the integrity and real-time nature of the data transmission.

It should be noted that for the communication ports of the desktop smart laser device, in addition to the cache indicated in step S210, an area, i.e., a first level cache, is also divided for each communication port for temporarily storing the external data received by the communication port.

For the performed motion control, the host computer generates an executable file based on the curve corresponding to the graphic to be engraved or cut, splits the executable file to obtain a number of frames of data, which will be sent to the desktop smart laser device frame by frame.

Correspondingly, the external data received by the desktop smart laser device includes a number of frames of data generated and split by the laser engraving or cutting curve performed by the host computer.

In step S320, the CPU of the desktop smart laser device takes out the several frames of data received by the communication port and stores them in the corresponding first level cache during the priority processing of data reception. The external data, for the desktop smart laser device, is the received temporary data, which includes the valid data, but is not limited to this, but also includes the data that needs to be retransmitted or discarded in case of error; and the received external data is also quickly called immediately, so the received external data is stored in the first level cache, which reduces the system overhead and improves the efficiency.

The data stored in the first level cache are verified in the order of data reception to obtain valid data, which are then stored in the cache corresponding to the communication port, i.e., the second level ring-shaped cache as described above.

The verification performed on the data includes data integrity and accuracy verification, and the data that passes the verification is valid data, and if the verification fails, the data that fails the verification needs to be processed according to the processing mechanism of the functional module to which the data belongs.

According to the different pre-configured processing mechanisms, the data that fails to pass the validation is either retransmitted, discarded, or subject to other processing, which is not limited here.

The data that passes the verification and is configured for motion control is deposited on the cache, i.e., the second level ring-shaped cache as described above. The data is wrote, via the write pointer, into the second level ring-shaped cache and is read via the read pointer, to be configured to generate the trajectory point queue.

In another exemplary embodiment, after step S210, the motion control method in the desktop smart laser device further includes:
determining whether the cache is empty, in response to that the cache is empty, permitting an initiation of the traversal of the trajectory point queue, and in response to that the cache is not empty, continuing to perform the generation of the trajectory point queue of the data configured for the motion control in the cache, i.e., continuing to perform step S210 to wait for the cache to be emptied.

Based on the principle of converting as much data as possible into trajectory point motion command, the data configured for motion control deposited in the cache is continuously taken out for the conversion of the trajectory point motion command, and added in the trajectory point queue, until the cache is emptied or the trajectory point queue is full, and only then the traversal of the trajectory point queue is initiated, i.e., step S240 is performed, thereby guaranteeing that once the engraving or cutting is initiated, the desktop smart laser device have a sufficient number of trajectory points for operation, and frequent starting and stopping of the process performed is also avoided.

In another exemplary embodiment, after step S210, the motion control method in the desktop smart laser device further includes:
determining whether the trajectory point queue is full, and in response to that the trajectory point queue is full, permitting an initiation of the traversal of the trajectory point queue, and in response to that the trajectory point queue is not full, continuing to perform the generation of the trajectory point queue of the data configured for motion control in the cache, i.e., executing step S210 until the trajectory point queues are all full, or the cache is empty.

Exemplarily, the “trajectory point queue is full” and the “cache is empty” are taken as a condition of whether the traversal of the trajectory point queue can be started, any one of the conditions is meet, the traversal of the trajectory point queue is permitted to be performed to ensure that there are a sufficient number of trajectory points to operate, to enhance the processing reliability of the desktop smart laser device.

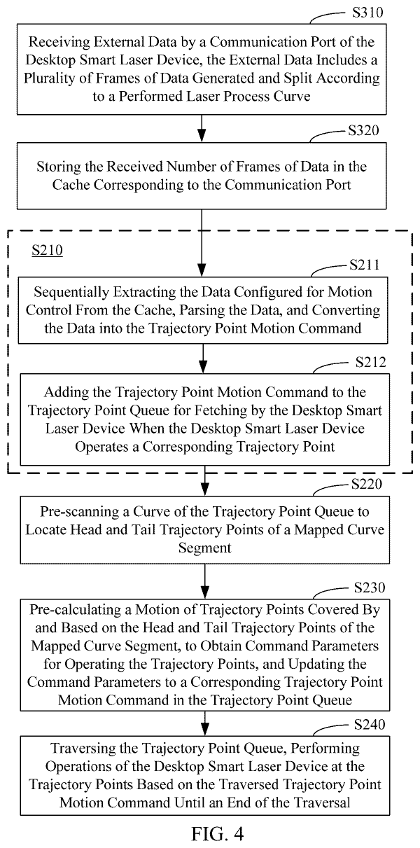

Referring to 4, FIG. 4 shows a flowchart of the step of the taking data configured for motion control in the cache to sequentially generate the trajectory point queue for the desktop smart laser device to perform the laser engraving or cutting process according to an embodiment of the present application. An embodiment of the present application provides step S210 of generating the trajectory point queue, which may include the following steps.

Step S211, sequentially extracting the data configured for motion control from the cache, parsing the data, and converting the data into the trajectory point motion command.

Step S212, adding the trajectory point motion command to the trajectory point queue for being fetched by the desktop smart laser device when the desktop smart laser device operates based on a corresponding trajectory point.

These two steps are described in detail below; respectively.

In step S211, sequentially storing the data for motion control in a frame of a unit in the cache, so the data is taken out of the cache sequentially and parsed. In terms of data structure, a frame of data carries a frame header, data, data length, data verification value, and a frame tail. The integrity verification, as described above, can confirm the integrity of the data based on the header and the tail of the frame.

The complete data is intercepted by the header and the tail of the frame and converted according to the type of command to which it belongs to obtain the trajectory point motion command. As pointed out in the foregoing, the data for motion control carries command parameters that each is generated based on the content selected for processing by the host computer, and can be converted directly into a trajectory point motion command.

In step S212, based on the first-in-first-out order of the trajectory point queue, the trajectory point motion command is written to the trajectory point queue by a pointer defined in the queue. In this circumstance, the data carried by each queue element in the trajectory point queue is the written trajectory point motion command.

It should be appreciated that the trajectory point queue describes and controls the processing performed by the desktop smart laser device according to each trajectory point. Correspondingly, the queue elements in the trajectory point queue correspond to the trajectory points, and the trajectory point motion command carried by the queue elements describes and controls how the motor, cutter head, and other actuating devices move, based on the corresponding trajectory points, to execute the processing content.

In the role of the cache and trajectory point queue, it not only ensures the order of the data, and then to protect the reliability of the desktop smart laser device, but also takes the cache and the trajectory point queue as a tool for able to simplify the laser engraving and cutting performed by the desktop smart laser device, thus greatly reducing the complexity and threshold, and breaking the difficulty that the traditional industrial laser cutting machine is only used in the industry, and becoming a machine with a low-threshold for ordinary users to use. The user-level desktop smart laser device is widely used in many scenarios such as home and school.

In step S220, even if the conditions permit, the processing of the desktop smart laser device is not instantly executed under the control of the generated trajectory point queue, but the curve pre-scanning of the trajectory point queue is executed.

It should be clear that the trajectory point queue is mapped correspondingly with the mapping of the processing curve, the processing state (laser use). The processing curve is a motion curve for the motor-driven tool such as the cutter head and/or laser head to perform laser cutting and/or engraving. The processing state is the laser power, laser mode, etc., used in the processing process.

The processing curve includes a number of curve segments, the processing process involved in different curve segments has very large differences, the processing process performed by different trajectory points in the same curve segments is relatively smooth, therefore, the curve of the trajectory point queue is pre-scanned, to determine the head and tail of each curve segment, thereby avoiding the subsequent recalculation of the actual processing process, reducing the amount of calculation of the subsequent processing process, and improving processing efficiency.

A number of trajectory points corresponding to the trajectory point queue to be traversed by the desktop smart laser device forms the processing curve, and correspondingly, the different curve segments in the processing curve are also composed of trajectory points, and the range of the curve segment is determined by its head and tail trajectory points.

Therefore, by performing the curve pre-scanning, the head and the tail trajectory points are located one by one for the mapped curve segments, such that the motion pre-calculation including each trajectory point is executed when the range of each curve segment is clearly determined.

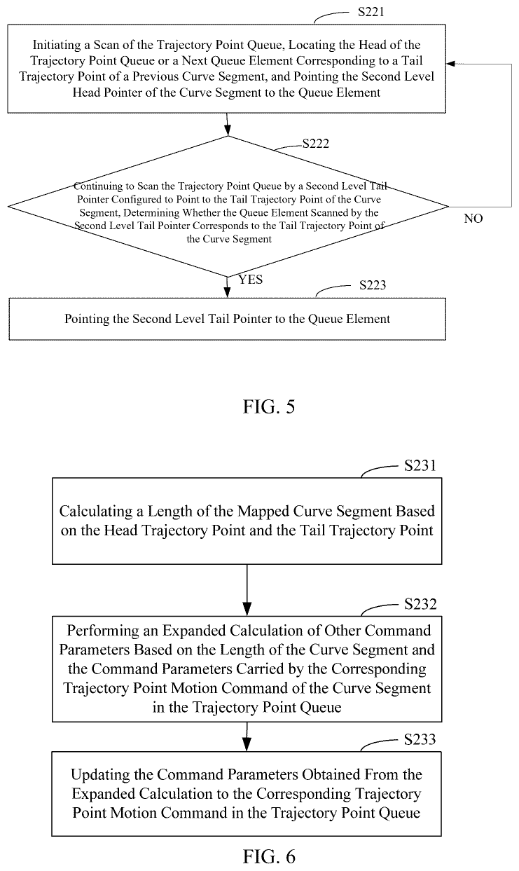

Referring to FIG. 5, FIG. 5 shows a flowchart of the step of pre-scanning a curve of the trajectory point queue to locate head and tail trajectory points of the mapped curve segment according to an embodiment of the present application. In an embodiment of the present application, a first level pointer and a second level pointer are defined in the trajectory point queue. The first level pointer points to the head and the tail of the trajectory point queue, and the second level pointer points to the queue elements corresponding to the head trajectory point and the tail trajectory point on the curve segment mapped with the trajectory point queue.

The described step S220 of pre-scanning a curve of the trajectory point queue to locate head and tail trajectory points of the mapped curve segment, may include the following steps:

Step S221, initiating a scan of the trajectory point queue, locating the head of the trajectory point queue or a next queue element corresponding to a tail trajectory point of a previous curve segment, and pointing the second level head pointer of the curve segment to the queue element.

Step S222, continuing to scan the trajectory point queue by a second level tail pointer configured to point to the tail trajectory point of the curve segment, determining whether the queue element scanned by the second level tail pointer corresponds to the tail trajectory point of the curve segment, and if so, executing S223, and if not, returning to continue executing step S222 until the queue element corresponding to the tail trajectory point is scanned.

Step S223, pointing the second level tail pointer to the queue element.

Through the execution of steps S221 to S223, the start point and the cut-off point of the curve segment are determined, and these steps are described in detail below; respectively,

In step S221, a curve pre-scanning is initiated for the trajectory point queue generated via step S210, and during the performed curve pre-scanning, the head trajectory point of the current curve segment is located by the head of the trajectory point queue, or the next queue element corresponding to the tail trajectory point of the previous curve segment obtained by the curve pre-scanning.

Specifically, two levels of pointers are respectively defined in the trajectory point queue, the first level pointer points to the head and tail corresponding to all trajectory points in the entire trajectory point queue, and the second level pointer points to the head and tail of the curve segment currently scanned. In the initiated trajectory point queue scan, for the curve segment currently scanned, if the curve segment is the first curve segment mapped by the trajectory point queue, the head of the queue pointed by the first level head pointer is directed as the head trajectory point of the curve segment.

If the curve segment is not the first curve segment mapped by the trajectory point queue, the next queue element to which the tail trajectory point of the previous curve segment is pointed is the head trajectory point of the curve segment.

The second level head pointer points to the located head trajectory point. The curve pre-scanning of the trajectory point queue is continued to obtain the tail trajectory point scanned by the curve segment.

In step S222, the second level tail pointer gradually moves forward, moves to the next queue element, and whether the queue element currently pointed to corresponds to the tail trajectory point of the curve segment is judged, and when the queue element currently pointed to does not correspond to the tail trajectory point, the second level tail pointer continues to move forward, and points to the next queue element for judgement.

By analogy, until the pointed-to queue element is judged to correspond to the tail trajectory point of the curve segment, the step S223 can be performed, so that the second level tail pointer marks the cut-off point for the curve segment by pointing to the queue element.

As a result, the curve pre-scanning corresponding to the curve segment is completed, and the motion pre-calculation of the curve segment can be performed by the step S230, so that the command parameters are updated for the subsequent trajectory points to be performed, thus minimizing the amount of computation in the traversal process.

It should be added here that whether the pointed-to queue element corresponds to the tail trajectory point of the curve segment can be determined based on the command parameters carried in the trajectory point motion command, such as the point type, exemplarily, the point type describes the attributes such as delay, state change, etc. of the motion based on the corresponding trajectory point.

In step S230, after a start point and a cut-off point of the scanned curve segment are determined by the curve pre-scanning, a motion pre-calculation of the covered trajectory points can be carried out on the curve segment to obtain the command parameters of the trajectory points.

The pre-calculated command parameters more accurately describe and control the motion of the actuators in the desktop smart laser device. Therefore, the command parameters are updated in the corresponding queue elements in the trajectory point queue. The trajectory point motion command carrying richer and more accurate command parameters will result in more reliable and accurate processing performed by the desktop smart laser device.

Exemplarily, the pre-calculated command parameters may include information such as the position vectors of the corresponding trajectory points in three-dimensional space. For example, after the head and tail trajectory points of the currently scanned curve segment are determined, the length of the curve segment can be obtained, and then according to the length, pre-calculations such as position determination and speed planning can be carried out on the operation of the trajectory points, so as to expand the command parameters carried by the trajectory point motion command.

Referring to FIG. 6, FIG. 6 shows a flowchart of the step of pre-calculating the motion of trajectory points covered by and based on the head and tail trajectory points of the mapped curve segment, obtaining operating command parameters of the trajectory points, and updating to a corresponding trajectory point motion command in the trajectory point queue according to an embodiment of the present application. In an embodiment of the present application, the step S230 of pre-calculating the motion of trajectory points covered by and based on the head and tail trajectory points of the mapped curve segment, to obtain operating command parameters of the trajectory points, and updating the command parameters to a corresponding trajectory point motion command in the trajectory point queue, may comprise the following steps.

Step S231, calculating a length of the mapped curve segment based on the head trajectory point and the tail trajectory point.

Step S232, performing an expanded calculation of other command parameters based on the length of the curve segment and the command parameters carried by the corresponding trajectory point motion command of the curve segment in the trajectory point queue.

Step S233, updating the command parameters obtained from the expanded calculation to the corresponding trajectory point motion command in the trajectory point queue.

These steps are described in detail below, respectively.

In step S231, the length of the present curve segment is obtained from the head trajectory point and the tail trajectory point obtained by the positioning. The obtained length of the curve segment facilitates the implementation of motion pre-calculation processes such as speed planning for the trajectory points within the curve segment, thereby facilitating the improvement of the accuracy of motion and processing on the curve segment.

In step S232, in the motion pre-calculation of the curve segment obtained from the current curve pre-scanning, based on the length of the curve segment and the obtained command parameters of the curve segment, the performed pre-calculation is to expand other command parameters for the trajectory points on the curve segment, so as to enhance the accuracy of the operation of the curve segment, i.e., the operation of each trajectory point on the curve segment.

For example, the length of the curve segment and its corresponding position on the processing content, i.e., the position of the point can be pre-calculated to obtain the position vector of the corresponding trajectory point in the three-dimensional space; in addition, according to the length of the curve segment, the speed planning can also be completed through the performed pre-calculation process, so as to control the change of the speed through the algorithm. Specifically, the motion pre-calculation is currently performed for the curve segment, an acceleration phase and a deceleration phase existed are determined, so as to facilitate the traversal of the trajectory points, i.e., in the execution of step S240, the speed of each trajectory point can be processed according to the speed, acceleration, or deceleration indicated by the corresponding command parameter of each trajectory point, in order to adapt to the planned acceleration phase or deceleration phase.

For the velocity planning performed, it is understood that the execution of the motion on the curve segment tends to plan an acceleration phase and/or a deceleration phase in terms of velocity, and for the motion on each trajectory point, it is necessary to judge whether or not the acceleration time point is reached according to the distance it has currently travelled on the curve segment, and thus to set the acceleration associated with its entry into the acceleration phase.

Similarly, for the planned deceleration phase, whether or not the deceleration time point is reached is judged based on the distance remaining in the current curve segment, and thus the deceleration for entering the deceleration phase is set.

In step S233, the command parameters obtained by the expanded calculation is updated to the queue elements of the trajectory point queue according to the corresponding trajectory points, which are then used for the traversal of the trajectory point queue in the subsequent execution.

As a result, the pre-calculation of the required parameters can be carried out between the traversal of the trajectory point queue, so that the traversals performed subsequently do not need to carry out the calculation of the parameters again, which ensures the efficiency of operation.

In step S240, under the normal state of the desktop smart laser device, after completing the pre-calculation of all curve segments, the traversal of the trajectory point queue is initiated, so as to operate the curve segments one by one and the trajectory points on the curve segments, and then ultimately realize the engraving or cutting of the desktop smart laser device on each of the trajectory points.

Exemplarily, as noted above, the traversal of the trajectory point queue is allowed to be performed under the condition that the cache is determined to be empty, or the trajectory point queue is determined to be full.

It should be noted that the operation of each curve segment refers to the execution process of sending the corresponding trajectory operation command, and that each curve segment indispensably contains a number of trajectory points, and therefore, the operation of the curve segment is a process in which a number of trajectory points operate separately.

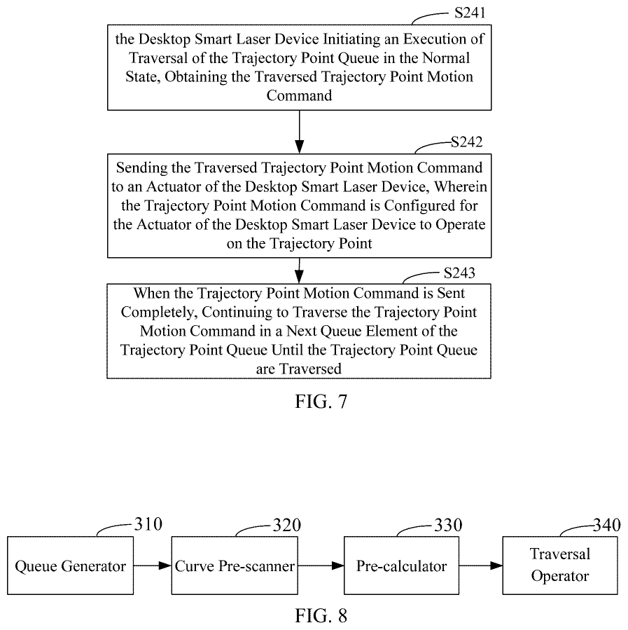

Referring to FIG. 7, FIG. 7 shows a flowchart of traversing the trajectory point queue, performing an operation of the desktop smart laser device at the trajectory point based on the traversed trajectory point motion command until an end of the traversal. In this embodiment of the present application, the motion state of the desktop smart laser device includes a normal state and a suspended state, and the step S240 of traversing the trajectory point queue, performing an operation of the desktop smart laser device at the trajectory point based on the traversed trajectory point motion command until an end of the traversal may include the following steps:

Step S241, the desktop smart laser device initiating an execution of traversal of the trajectory point queue in the normal state, obtaining the traversed trajectory point motion command.

Step S242, sending the traversed trajectory point motion command to an actuator of the desktop smart laser device, wherein the trajectory point motion command is configured for the actuator of the desktop smart laser device to operate on the trajectory point.

Step S243, when the trajectory point motion command is sent completely, continuing to traverse the trajectory point motion command in a next queue element of the trajectory point queue until the trajectory point queue are traversed.

These steps are described in detail below:

In step S241, it should first be stated that the motion state of the desktop smart laser device refers to the state of the actuator used to perform laser process. In the normal state, the actuator moves from one trajectory point to the next trajectory point and performs laser process, and enters a pause state when an abnormality such as an interruption occurs.

The desktop smart laser device in the normal state initiates the execution of the traversal of the trajectory point queue, and with respect to the queue elements in the trajectory point queue, from which the trajectory point motion command is extracted one by one, so as to initiate the motion and processing on the corresponding trajectory point.

In step S242, sending the trajectory point motion command obtained from the current traversal to the corresponding actuator to complete the traversal and operation of the current trajectory point, and then jumping to the next queue element through the execution of step S243, to obtain the trajectory point motion command carried by the next queue element, to complete the traversal and operation of the next queue element until the entire traversal of the entire trajectory point queue is completed.

As a result, the traversal of the trajectory point queue triggers the motion of the corresponding actuator in the desktop smart laser device at each trajectory point on the processed material and the engraving or cutting of the corresponding actuator in the desktop smart laser device on the processed material based on the trajectory points.

In addition, during the traversal of the trajectory point queue performed, a processing mechanism of the pause command is configured. Exemplarily, after receiving the pause command, the execution is not stopped immediately, but continues to move along the set curve segment and starts decelerating according to the deceleration carried in the trajectory point motion command until the speed drops to 0 to complete the decelerating process and enter the pause state, thereby avoiding the impact caused by the immediate shutdown to the device, so that the machining trajectory can be continued to maintain the integrity of the machining product as much as possible, reducing the impact caused by the pause.

Through the exemplary embodiments as described above, it can be clear that the desktop smart laser device achieved through the motion control process as described above overcomes the limitations of the traditional industrial laser cutting machine with large volume, complex installation, high threshold of use and insufficient safety, thereby providing users with a stable, reliable and accurate laser experience, which greatly reduces the difficulty of using the laser, such that any user can use the laser to create.

By means of the exemplary embodiment as described above, the motion control and laser use of the desktop smart laser device at each trajectory point is achieved. It can be understood that the trajectory point motion command used for each trajectory point sets the speed parameter for each axis motor of the actuator, and the acceleration range, etc., so as to control the speed change to a suitable value according to the corresponding trajectory point's position vector, direction, and distance relative to the inflection point in three-dimensional space under the effect of the pre-calculated speed planning, thereby ensuring the smoothness of speed change and the efficiency of the overall operation in the process of the specific execution.

The following is an example of the user using a desktop smart laser device for laser cutting and engraving to illustrate the motion control implemented in the present application.

The adapted desktop laser device is configured with a computer terminal, which is used to provide content such as a processing pattern for the engraving and cutting performed by the desktop laser device, thereby enabling the desktop laser device to perform engraving or cutting of the laser on a specified material according to the processing pattern.

Specifically, the computer terminal, as a host computer, obtains a processing pattern hand-drawn by the user, or a processing pattern selected by the user, generates an executable file for the desktop smart laser device based on the curve trajectories existed on the processing pattern, the executable file may be a G-code file, and is used for controlling the motion of the desktop smart laser device and the use of the laser, so as to engrave or cut the processing pattern on the designated material.

The computer splits the executable file into a number of frames and sends the data to the desktop laser device in a frame of a unit.

The communication port of the desktop laser device is triggered to receive the data. At this time, the CPU interrupts the motion of the current programme, gives priority to data reception, and stores the data in the first level cache corresponding to the communication port.

On the other hand, since a frame of data is composed of a head+data+data length+data verification value+tail, for the first level cache, the first level cache is reset when the head of the frame is received, and then the currently transmitted frame of data is started to be received.

Of course, if the first level cache is full and the head of the frame cannot be received, the first level cache will also be cleared. The reset first level cache starts to receive data until the tail of the frame is received.

Each communication port is configured with its own corresponding first level cache for temporary storage of data received by that communication port. The data in the first level cache is verified sequentially and the valid data is obtained and stored in the second level ring-shaped cache.

The data that fails to pass the verification can be retransmitted or discarded according to the set processing mechanism, which is not limited here.

At this point, the data in the second level ring-shaped cache can be used for the motion of the curve segments and trajectory points corresponding to the machining pattern and for the use of the laser.

The data is taken out of the second level ring-shaped cache, parsed and converted into trajectory point motion command, the sequentially converted trajectory point motion command are sequentially added to the trajectory point queue, and the traversal of the trajectory point queue is permitted to be performed when the second level ring-shaped cache is empty or the trajectory point queue is full.

For the generated trajectory point queue, a first level pointer and a second level command are defined to facilitate the pre-calculation execution for the traversal of the trajectory point queue, to reduce the amount of computation in the actual traversal process.

Specifically, the first level pointer and the second level pointer include a head pointer and a tail pointer. The first level pointer is used for the control of the queue elements in the entire trajectory point queue, and the second level pointer performs the pointing control of the corresponding queue elements for a curve segment mapped by the trajectory point queue.

Under the action of the first level pointer and the second level pointer, the curve pre-scanning is performed on the trajectory point queue, and through the execution of the curve pre-scanning, the head trajectory point and the tail trajectory point are determined for the curve segment currently pointed to, and then the length of the curve segment is obtained, and then the motion pre-calculation of the curve segment is performed for expanding the command parameter of the trajectory point motion command, and is updated to the trajectory point queue.

And so on, the scanning and pre-calculation of all curve segments in the trajectory point queue is completed.

If the desktop smart laser device is currently in a normal state, the desktop smart laser device initiates the traversal of the trajectory point queue, takes out the trajectory point motion command from the traversed queue elements, and sends it to enable the actuator of the desktop smart laser device to drive its own operation on the corresponding trajectory point and the use of the laser based on the trajectory point motion command, and so on to complete the laser engraving or cutting of each trajectory point.

Referring to FIG. 8, FIG. 8 provides a motion control device in a desktop smart laser device according to an embodiment of the present application, the motion control device is configured in the desktop smart laser device, the motion control device includes:
a queue generator 310 configured to sequentially generating a trajectory point queue for the desktop smart laser device to perform laser engraving or cutting based on data configured for motion control in a cache, wherein a trajectory point motion command in queue elements in the trajectory point queue is configured to instruct the laser engraving or cutting operated by corresponding trajectory points;
a curve pre-scanner 320 configured to pre-scan a curve of the trajectory point queue to locate head and tail trajectory points of a mapped curve segment;
a pre-calculator 330 configured to pre-calculate a motion of trajectory points covered by and based on the head and tail trajectory points of the mapped curve segment, to obtain command parameters for operating the trajectory points, and update the command parameters to a corresponding trajectory point motion command in the trajectory point queue;
a traversal operator 340 configured to traverse the trajectory point queue, perform operations of the desktop smart laser device at the trajectory points based on the traversed trajectory point motion command until an end of the traversal.

In one embodiment, before the sequentially generating the trajectory point queue for the desktop smart laser device to perform laser process based on data configured for motion control in the cache, the apparatus is further configured to:
receive external data by a communication port of the desktop smart laser device, wherein the external data includes a plurality of frames of data generated and split according to a performed laser process curve; and
store the received number of frames of data in the cache corresponding to the communication port.

In one embodiment, after the step of sequentially generating the trajectory point queue for the desktop smart laser device to perform laser process based on data configured for motion control in the cache, the apparatus is further configured to:
determine whether the cache is empty, and in response to that the cache is empty, permit an initiation of the traversal of the trajectory point queue.

In one embodiment, after the step of taking data configured for motion control in the cache to sequentially generate the trajectory point queue for the desktop smart laser device to perform the laser process, the apparatus is further configured to:
determine whether the trajectory point queue is full, and in response to that the trajectory point queue is full, permit an initiation of the traversal of the trajectory point queue.

In one embodiment, the sequentially generating the trajectory point queue for the desktop smart laser device to perform laser process based on data configured for motion control in the cache, includes:
sequentially extracting the data configured for motion control from the cache, parsing the data, and converting the data into the trajectory point motion command; and
adding the trajectory point motion command to the trajectory point queue for fetching by the desktop smart laser device when the desktop smart laser device operates the corresponding trajectory point.

In one embodiment, a first level pointer and a second level pointer are defined in the trajectory point queue, the first level pointer is configured to point to a head and a tail of the trajectory point queue, and the second level pointer is configured to point to a queue element corresponding to a head trajectory point and a tail trajectory point on the mapped curve segment in the trajectory point queue;
wherein the pre-scanning the curve of the trajectory point queue to locate the head and tail trajectory points of the mapped curve segment includes:
initiating a scan of the trajectory point queue, locating the head of the trajectory point queue or a next queue element corresponding to a tail trajectory point of a previous curve segment, and pointing a second level head pointer of the curve segment to the queue element;
continuing to scan the trajectory point queue by a second level tail pointer configured to point to the tail trajectory point of the curve segment, determining whether the queue element scanned by the second level tail pointer corresponds to the tail trajectory point of the curve segment;
in response to that the queue element scanned by the second level tail pointer corresponds to the tail trajectory point of the curve segment, pointing the second level tail pointer to the queue element; and
in response to that the queue element scanned by the second level tail pointer does not

correspond to the tail trajectory point of the curve segment, continuing to scan the trajectory point queue until the queue element corresponding to the tail trajectory point is scanned.

In one embodiment, the pre-calculating a motion of trajectory points covered based on the head and tail trajectory points of the mapped curve segment, obtaining command parameters for operating the trajectory points, and updating to the corresponding trajectory point motion command in the trajectory point queue, includes:
calculating a length of the mapped curve segment based on the head trajectory point and the tail trajectory point;
performing an expanded calculation of other command parameters based on the length of the curve segment and the command parameters carried by the corresponding trajectory point motion command of the curve segment in the trajectory point queue; and
updating the command parameters obtained from the expanded calculation to the corresponding trajectory point motion command in the trajectory point queue.

In one embodiment, a motion state of the desktop smart laser device comprises a normal state and a paused state;
the traversing the trajectory point queue, performing the operation of the desktop smart laser device at the trajectory point based on the traversed trajectory point motion command until the end of the traversal includes:
the desktop smart laser device initiating an execution of traversal of the trajectory point queue in the normal state, obtaining the traversed trajectory point motion command;
sending the traversed trajectory point motion command to an actuator of the desktop smart laser device, wherein the trajectory point motion command is configured for the actuator of the desktop smart laser device to operate based on the trajectory point; and
when the trajectory point motion command is sent completely, continuing to traverse the trajectory point motion command in a next queue element of the trajectory point queue until the trajectory point queue are traversed.

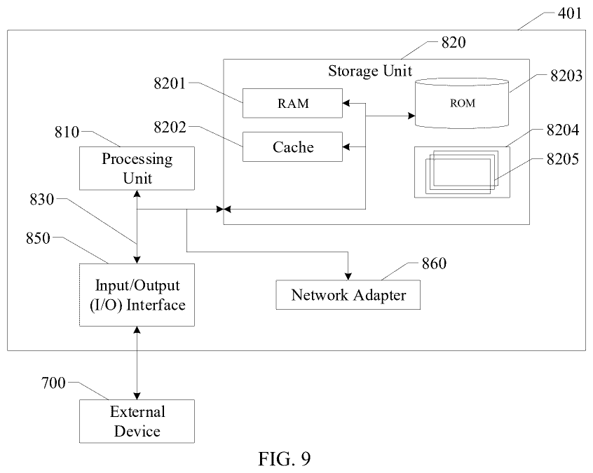

The motion control method in the desktop smart laser device according to embodiments of the present application may be implemented by the desktop smart laser device of FIG. 9. A desktop smart laser device according to embodiments of the present application is described with reference to FIG. 9 below. The desktop smart laser device shown in FIG. 9 is merely an example and should not impose any limitations on the functions and use scope of embodiments of the present application.

As shown in FIG. 9, the desktop smart laser device may be similar to a general-purpose computing device, and the components of the desktop smart laser device may include, but are not limited to, at least one processing unit 810, at least one storage unit 820 as described above, a bus 830 connecting the different system components including the storage unit 820 and the processing unit 810, and an actuator undertaking a laser processing task (not shown in the figure).

The storage unit stores program code, the program code is executable by the processing unit 810, such that the processing unit 810 performs the steps according to various exemplary embodiments of the present application as described in the description portion of the exemplary method described above in this specification. For example, the processing unit 810 may perform various steps as shown in FIG. 2.

The storage unit 820 may include a readable medium in the form of a volatile storage unit, such as a random access memory (RAM) unit 8201 and/or a cache memory unit 8202, and may also include a read-only memory (ROM) unit 8203.

The storage unit 820 may also include a program/utility 8204 having a set (at least one) of program modules 8205, such that the program modules 8205 include, but are not limited to: an operating system, one or more applications, other program modules, and program data, and each of these examples or some combination of these may include an implementation of a network environment.

The bus 830 may be a local bus that represents one or more of several types of bus structures, including a memory cell bus or memory cell controller, a peripheral bus, a graphics acceleration port, a processing unit, or a local bus that uses any of the multiple bus structures.

The desktop smart laser device may also communicate with one or more external devices 700 (e.g., keyboards, pointing devices, Bluetooth devices, etc.). This communication may be carried out via an input/output (I/O) interface 850. And the desktop smart laser device may also communicate with one or more networks (e.g., a local area network (LAN), a wide area network (WAN), and/or a public network, such as the Internet) via a network adapter 860. As shown, the network adapter 860 communicates with other modules via the bus 830. It should be appreciated that, although not shown in the figures, other hardware and/or software modules may be used in conjunction with the desktop smart laser device, including, but not limited to: a microcode, device drives, redundant processing units, external disk drive arrays, RAID systems, a tape driver, and data backup storage systems.

By the foregoing description of implementations, it is readily understood by those skilled in the art that the example implementations described herein may be implemented by software, or may be implemented by software in combination with the necessary hardware. Thus, a technical solution according to an embodiment of the present application may be embodied in the form of a software product that may be stored in a non-volatile storage medium (which may be a CD-ROM, a USB, a removable hard drive, etc.) or on a network, and that includes a number of command for causing a computing device (which may be a personal computer, a server, a terminal device, or a network device, etc.) to perform a method according to an embodiment of the present application.

In exemplary embodiments of the present application, there is also provided a computer program medium, on which the computer-readable command is stored, when the computer-readable command is performed by a processor of a computer, it causes the computer to perform the method described in the method implementation section above.

According to an embodiment of the present application, there is also provided a program product for implementing the method of the above method embodiments, which may employ a portable compact disc read-only memory (CD-ROM) and include program code, and which may be operated on a terminal device, such as a personal computer. However, the program products of the present application are not limited thereto, and herein a readable storage medium may be any tangible medium containing or storing a program that may be used by or in combination with a command execution system, apparatus or device.

The programme product may employ any combination of one or more readable medium. The readable medium may be a readable signal medium or a readable storage medium.

The readable storage medium may be, for example, but is not limited to, a system, device, or apparatus, or device that is electrical, magnetic, optical, electromagnetic, infrared, or semiconductor, or any combination of the above. More specific examples of readable storage medium (a non-exhaustive list) include: an electrical connection having one or more wires, a portable disc, a hard disc, a random access memory (RAM), a read-only memory (ROM), an erasable programmable read-only memory (EPROM or flash memory), a fibre optic, a portable compact disc read-only memory (CD-ROM), an optical storage device, a magnetic storage device, or any suitable combination of the foregoing.

The computer readable signal medium may include a data signal propagated in baseband or as part of a carrier carrying readable program code. Such propagated data signals may take a variety of forms, including, but not limited to, electromagnetic signals, optical signals, or any suitable combination of the foregoing. The readable signal medium may also be any readable medium other than a readable storage medium that sends, propagates, or transmits a programme for use by, or in conjunction with, a command execution system, apparatus, or device.

The program code contained on the readable medium may be transmitted using any suitable medium, including, but not limited to, wireless, wired, fibre optic cable, RF, etc., or any suitable combination thereof.

The program code for performing the operations of the present application may be written in any combination of one or more programming languages, the programming languages including object-oriented programming languages—such as Java, C++, etc., and also conventional procedural programming languages—such as the “C” language or similar programming languages. The programme code may be performed entirely on the user computing device, partially on the user device, as a stand-alone software package, partially on the user computing device and partially on a remote computing device, or entirely on a remote computing device or server. In situations involving a remote computing device, the remote computing device may be connected to the user computing device via any kind of network, including a local area network (LAN) or a wide area network (WAN), or, alternatively, may be connected to an external computing device (e.g., by using an Internet service provider to connect via the Internet).

It should be noted that although a number of modules or units of the device for action execution are mentioned in the detailed description above, this division is not mandatory. Indeed, according to embodiments of the present application, the features and functions of two or more modules or units described above may be specified in a single module or unit. Conversely, the features and functions of one module or unit described above may be divided to be specified by more than one module or unit.

Furthermore, although the various steps of the method in the present application are described in the accompanying drawings in a particular order, it is not required or implied that the steps must be performed in that particular order or that all of the steps shown must be performed in order to achieve the desired result. Additional or alternatively, certain steps may be omitted, multiple steps may be combined to be performed as a single step, and/or a single step may be broken down to be performed as multiple steps, etc.

By the above description of the embodiments, it is readily understood by those skilled in the art that the embodiments described herein may be implemented by way of software, or by way of software in combination with the necessary hardware. Thus, the technical solution according to the presently disclosed embodiments may be embodied in the form of a software product that may be stored in a non-volatile storage medium (which may be a CD-ROM, a USB, a removable hard drive, etc.) or on a network, and that includes a number of command to cause a computing device (which may be a personal computer, a server, a mobile terminal, or a network device, etc.) to perform the method according to the method according to the embodiments of the present application.

Other embodiments of the present application will readily come to mind to those skilled in the art upon consideration of the specification and practice of the present application disclosed herein. The present application is intended to cover any variations, uses, or adaptations of the present application that follow the general principles of the present application and include means of common knowledge or those skilled in the art not disclosed herein. The specification and embodiments are to be regarded as exemplary only, and the true scope of the present application is indicated by the appended claims.

1. A motion control method of a desktop smart laser device, comprising:
sequentially generating a trajectory point queue for the desktop smart laser device to perform laser process based on data configured for motion control in a cache, wherein a trajectory point motion command in queue elements in the trajectory point queue is configured to instruct an operation of laser process of corresponding trajectory points;
pre-scanning a curve of the trajectory point queue to locate head and tail trajectory points of a mapped curve segment;
pre-calculating a motion of trajectory points covered by and based on the head and tail trajectory points of the mapped curve segment, to obtain command parameters for operating the trajectory points, and updating the command parameters to a corresponding trajectory point motion command in the trajectory point queue; and
traversing the trajectory point queue, performing operations of the desktop smart laser device at the trajectory points based on the traversed trajectory point motion command until an end of the traversal.

2. The method according to claim 1, wherein before sequentially generating the trajectory point queue for the desktop smart laser device to perform laser process based on data configured for motion control in the cache, the method further comprises:
receiving external data by a communication port of the desktop smart laser device, wherein the external data comprises a plurality of frames of data generated and split according to a performed laser process curve; and
storing the received number of frames of data in the cache corresponding to the communication port.

3. The method according to claim 1, wherein after sequentially generating the trajectory point queue for the desktop smart laser device to perform laser process based on data configured for motion control in the cache, the method further comprises:
determining whether the cache is empty, and in response to that the cache is empty, permitting an initiation of the traversal of the trajectory point queue.

4. The method according to claim 1, wherein after sequentially generating the trajectory point queue for the desktop smart laser device to perform laser process based on data configured for motion control in the cache, the method further comprises:
determining whether the trajectory point queue is full, and in response to that the trajectory point queue is full, permitting an initiation of the traversal of the trajectory point queue.

5. The method according to claim 1, wherein sequentially generating the trajectory point queue for the desktop smart laser device to perform laser process based on data configured for motion control in the cache comprises:
sequentially extracting the data configured for motion control from the cache, parsing the data, and converting the data into the trajectory point motion command; and
adding the trajectory point motion command to the trajectory point queue for fetching by the desktop smart laser device when the desktop smart laser device operates the corresponding trajectory point.

6. The method according to claim 1, wherein a first level pointer and a second level pointer are defined in the trajectory point queue, the first level pointer is configured to point to a head and a tail of the trajectory point queue, and the second level pointer is configured to point to a queue element corresponding to a head trajectory point and a tail trajectory point on the mapped curve segment in the trajectory point queue;
wherein pre-scanning the curve of the trajectory point queue to locate the head and tail trajectory points of the mapped curve segment comprises:
initiating a scan of the trajectory point queue, locating the head of the trajectory point queue or a next queue element corresponding to a tail trajectory point of a previous curve segment, and pointing a second level head pointer of the curve segment to the queue element;
continuing to scan the trajectory point queue by a second level tail pointer configured to point to the tail trajectory point of the curve segment, determining whether the queue element scanned by the second level tail pointer corresponds to the tail trajectory point of the curve segment;
in response to that the queue element scanned by the second level tail pointer corresponds to the tail trajectory point of the curve segment, pointing the second level tail pointer to the queue element; and
in response to that the queue element scanned by the second level tail pointer does not correspond to the tail trajectory point of the curve segment, continuing to scan the trajectory point queue until the queue element corresponding to the tail trajectory point is scanned.

7. The method according to claim 1, wherein pre-calculating the motion of trajectory points covered based on the head and tail trajectory points of the mapped curve segment, to obtain command parameters for operating the trajectory points, and updating to the corresponding trajectory point motion command in the trajectory point queue, comprises:
calculating a length of the mapped curve segment based on the head trajectory point and the tail trajectory point;
performing an expanded calculation of other command parameters based on the length of the curve segment and the command parameters carried by the corresponding trajectory point motion command of the curve segment in the trajectory point queue; and
updating the command parameters obtained from the expanded calculation to the corresponding trajectory point motion command in the trajectory point queue.

8. The method according to claim 1, wherein a motion state of the desktop smart laser device comprises a normal state and a paused state;
wherein traversing the trajectory point queue, performing the operation of the desktop smart laser device at the trajectory point based on the traversed trajectory point motion command until the end of the traversal comprises:
the desktop smart laser device initiating an execution of traversal of the trajectory point queue in the normal state, obtaining the traversed trajectory point motion command;
sending the traversed trajectory point motion command to an actuator of the desktop smart laser device, wherein the trajectory point motion command is configured for the actuator of the desktop smart laser device to operate based on the trajectory point; and
when the trajectory point motion command is sent completely, continuing to traverse the trajectory point motion command in a next queue element of the trajectory point queue until the trajectory point queue are traversed.

9. (canceled)

10. A desktop smart laser device, comprising:
a memory, storing a computer readable command;
a processor, reading the computer readable command stored in the memory to perform a motion control method of a laser device, wherein the method comprises:
sequentially generating a trajectory point queue for the desktop smart laser device to perform laser process based on data configured for motion control in a cache, wherein a trajectory point motion command in queue elements in the trajectory point queue is configured to instruct an operation of laser process of corresponding trajectory points;
pre-scanning a curve of the trajectory point queue to locate head and tail trajectory points of a mapped curve segment;
pre-calculating a motion of trajectory points covered by and based on the head and tail trajectory points of the mapped curve segment, to obtain command parameters for operating the trajectory points, and updating the command parameters to a corresponding trajectory point motion command in the trajectory point queue; and
traversing the trajectory point queue, performing operations of the desktop smart laser device at the trajectory points based on the traversed trajectory point motion command until an end of the traversal.

11. The method according to claim 1, wherein the desktop smart laser device is adapted to each communication port, and a corresponding cache is divided for each communication port, and external data received by the desktop smart laser device through each communication port is stored in the corresponding cache for use.

12. The method according to claim 1, wherein a generation of the trajectory point queue is a process that the data for motion control is continuously taken out of the cache and converted into trajectory point motion command, and are added to the trajectory point queue, and the trajectory point motion command forms data existed in the queue elements.

13. The method according to claim 11, wherein a first level cache is configured for storing the external data received by the corresponding communication port, a second level ring-shaped cache is configured for storing valid data in the first level cache, and the data stored for motion control is the valid data, and is stored in the second level ring-shaped cache.

14. The method according to claim 13, wherein in the second level ring-shaped cache, a read pointer and a write pointer are set; wherein the read pointer is configured to point to readable data in the second level ring-shaped cache, and the write pointer is configured to point to writable data in the second level ring-shaped cache, and reading and writing of the data in the second level ring-shaped cache is achieved by moving the read pointer and the write pointer.

15. The desktop smart laser device according to claim 10, wherein after sequentially generating the trajectory point queue for the desktop smart laser device to perform laser process based on data configured for motion control in the cache, the method further comprises:
determining whether the cache is empty, and in response to that the cache is empty, permitting an initiation of the traversal of the trajectory point queue.

16. The desktop smart laser device according to claim 10, wherein after sequentially generating the trajectory point queue for the desktop smart laser device to perform laser process based on data configured for motion control in the cache, the method further comprises:
determining whether the trajectory point queue is full, and in response to that the trajectory point queue is full, permitting an initiation of the traversal of the trajectory point queue.

17. The desktop smart laser device according to claim 10, wherein sequentially generating the trajectory point queue for the desktop smart laser device to perform laser process based on data configured for motion control in the cache comprises:
sequentially extracting the data configured for motion control from the cache, parsing the data, and converting the data into the trajectory point motion command; and
adding the trajectory point motion command to the trajectory point queue for fetching by the desktop smart laser device when the desktop smart laser device operates the corresponding trajectory point.

18. The desktop smart laser device according to claim 10, wherein a first level pointer and a second level pointer are defined in the trajectory point queue, the first level pointer is configured to point to a head and a tail of the trajectory point queue, and the second level pointer is configured to point to a queue element corresponding to a head trajectory point and a tail trajectory point on the mapped curve segment in the trajectory point queue;
wherein pre-scanning the curve of the trajectory point queue to locate the head and tail trajectory points of the mapped curve segment comprises:
initiating a scan of the trajectory point queue, locating the head of the trajectory point queue or a next queue element corresponding to a tail trajectory point of a previous curve segment, and pointing a second level head pointer of the curve segment to the queue element;
continuing to scan the trajectory point queue by a second level tail pointer configured to point to the tail trajectory point of the curve segment, determining whether the queue element scanned by the second level tail pointer corresponds to the tail trajectory point of the curve segment;
in response to that the queue element scanned by the second level tail pointer corresponds to the tail trajectory point of the curve segment, pointing the second level tail pointer to the queue element; and
in response to that the queue element scanned by the second level tail pointer does not correspond to the tail trajectory point of the curve segment, continuing to scan the trajectory point queue until the queue element corresponding to the tail trajectory point is scanned.

19. The desktop smart laser device according to claim 10, wherein pre-calculating the motion of trajectory points covered based on the head and tail trajectory points of the mapped curve segment, to obtain command parameters for operating the trajectory points, and updating to the corresponding trajectory point motion command in the trajectory point queue, comprises:
calculating a length of the mapped curve segment based on the head trajectory point and the tail trajectory point;
performing an expanded calculation of other command parameters based on the length of the curve segment and the command parameters carried by the corresponding trajectory point motion command of the curve segment in the trajectory point queue; and
updating the command parameters obtained from the expanded calculation to the corresponding trajectory point motion command in the trajectory point queue.

20. The desktop smart laser device according to claim 10, wherein a motion state of the desktop smart laser device comprises a normal state and a paused state;
wherein the traversing the trajectory point queue, performing the operation of the desktop smart laser device at the trajectory point based on the traversed trajectory point motion command until the end of the traversal comprises:
the desktop smart laser device initiating an execution of traversal of the trajectory point queue in the normal state, obtaining the traversed trajectory point motion command;
sending the traversed trajectory point motion command to an actuator of the desktop smart laser device, wherein the trajectory point motion command is configured for the actuator of the desktop smart laser device to operate based on the trajectory point; and
when the trajectory point motion command is sent completely, continuing to traverse the trajectory point motion command in a next queue element of the trajectory point queue until the trajectory point queue are traversed.

21. The desktop smart laser device according to claim 10, wherein a generation of the trajectory point queue is a process that data for motion control is continuously taken out of the cache and converted into the trajectory point motion command, and are added to the trajectory point queue, and the trajectory point motion command forms data existed in the queue elements.
